(19) United States
(12) Patent Application Publication
(10) Pub. No.: US 2006/0067723 A1
(43) Pub. Date: Mar. 30, 2006

(54) Operator module configured for detachable attachment to an imaging apparatus

(76) Inventor: Edmund H. James III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/957,094

(22) Filed: Sep. 30, 2004

(51) Int. Cl. G03G 15/00

(52) U.S. Cl. 399/81

(57) ABSTRACT

An imaging system includes an imaging apparatus having a print engine and an interface port, and an operator module configured for detachable electrical and mechanical attachment to the interface port. The operator module includes a memory device for storing data, a user interface and a dedicated power source electrically coupled to the user interface and the memory. The operator module is configured to facilitate user interaction with the imaging apparatus when the operator module is attached to the interface port. Also, the operator module is configured to facilitate portable data playback when the operator module is detached from the interface port.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates to an imaging apparatus, and, more particularly, to an operator module configured for detachable attachment to an imaging apparatus.

2. Description of the Related Art

An imaging apparatus forms an image on a sheet of print media, such as for example, paper or a transparency, by applying ink or toner onto the print medium. Such an imaging apparatus, in the form of an electrophotographic (EP) printer, forms a latent image on a photoconductive surface, which in turn is developed and transferred to a sheet of print media, such as paper. Such an imaging apparatus, in the form of an ink jet printer, forms an image on the sheet of print media by ejecting ink from a plurality of ink jetting nozzles of an ink jet printhead to form a pattern of ink dots on the sheet of print media. Such an ink jet printer typically includes a reciprocating printhead carrier that transports one or more ink jet printheads across the sheet of print media that is supported by a mid-frame along a bi-directional scanning path defining a print zone of the ink jet printer. Such imaging apparatus, particularly in the form of an ink jet printer, have been adapted to print images in a photo quality printing mode, often using six-color printing.

Digital cameras may include a removable memory, such as a memory card, for storing digital images. These images can be subsequently modified by the user using built-in features of the digital camera. The images can also be downloaded, via a memory card reader or direct cable connection, to a typical personal computer, and then the images may be modified using commercially available software. Thereafter, the images may be printed by the imaging apparatus.

In order to ease the transfer of images to be printed to the imaging apparatus, one type of imaging apparatus may include a docking station for directly receiving a digital camera, and the imaging apparatus may be operated in a standalone mode. Printing using an imaging apparatus in a standalone mode has the advantage of printing without the need for a personal computer.

Regardless of which technology is used, however, multiple devices are required, some of which may include redundant functions that contribute to the overall cost of an imaging system.

### SUMMARY OF THE INVENTION

The present invention provides an operator module configured for detachable attachment to an imaging apparatus. Such an operator module may, for example, provide a user interface to the imaging apparatus, as well as serve as a personal portable data acquisition and storage device, and may be used, for example, for the mass storage of digital images and/or audio files.

The invention, in one form thereof, relates to an imaging system. The system includes an imaging apparatus having a print engine and an interface port, and an operator module configured for detachable electrical and mechanical attachment to the interface port. The operator module includes a memory device for storing data, a user interface, and a dedicated power source electrically coupled to the user interface and the memory device. The operator module is configured to facilitate user interaction with the imaging apparatus when the operator module is attached to the interface port. Also, the operator module is configured to facilitate portable data playback when the operator module is detached from the interface port.

The invention, in another form thereof, relates to an operator module. The operator module includes a controller and a user interface communicatively coupled to the controller. A memory device is communicatively coupled to the controller. A dedicated power source supplies power to the controller, the user interface and the memory. An electrical/mechanical interface facilitates detachable attachment of the operator module to an imaging apparatus. The operator module facilitates user interaction with the imaging apparatus when the operator module is attached to the imaging apparatus, and the operator module facilitates portable data playback via the user interface and the memory when the operator module is detached from the imaging apparatus.

An advantage of the present invention is that it may provide as a single unit both a user interface to an imaging apparatus and a personal portable data playback, acquisition and storage device.

Another advantage of the present invention is that the overall cost of an imaging system can be reduced by reducing the number of devices in the system having redundant functionality.

Yet another advantage of the present invention is that it provides portable mass storage for digital images and/or audio files.

### BRIEF DESCRIPTION OF THE DRAWINGS

The above-mentioned and other features and advantages of this invention, and the manner of attaining them, will become more apparent, and the invention will be better understood by reference to the following description of an embodiment of the invention taken in conjunction with the accompanying drawing, wherein:

FIG. 1 is a diagrammatic depiction of an imaging system that utilizes the present invention.

The exemplifications set out herein illustrate an exemplary embodiment of the invention, and such exemplifications are not to be construed as limiting the scope of the invention in any manner.

### DETAILED DESCRIPTION OF THE INVENTION

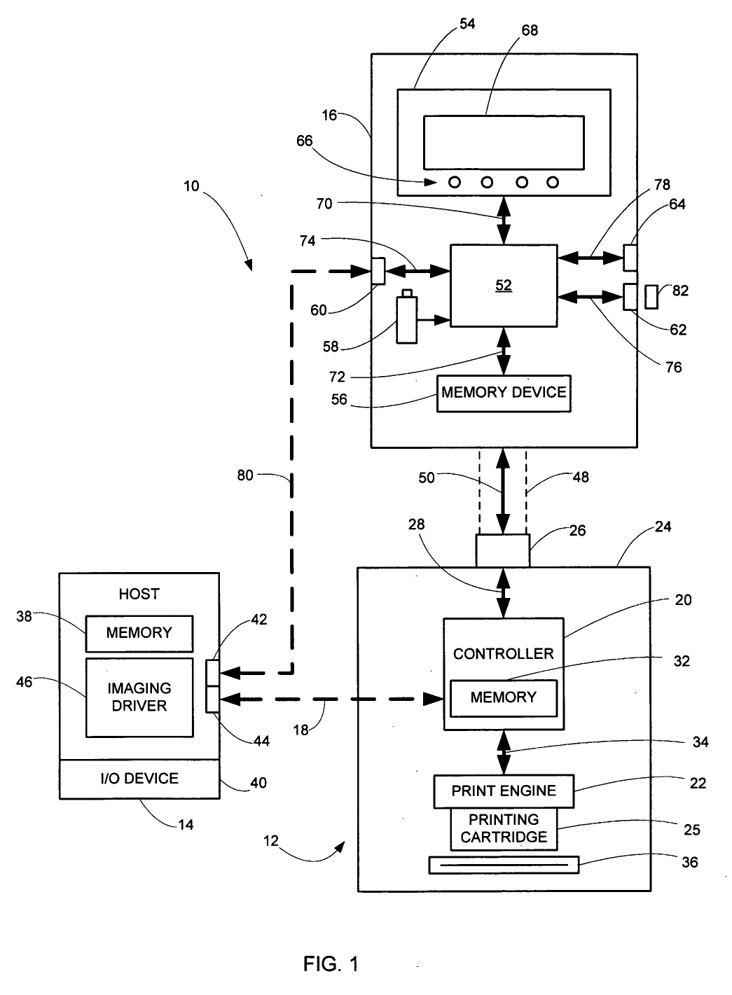

Referring now to FIG. 1, there is shown a diagrammatic depiction of an imaging system 10 embodying the present invention. Imaging system 10 includes an imaging apparatus 12, a host 14, and an operator module 16. Imaging apparatus 12 communicates with host 14 via a communications link 18. As used herein, the term “communications link” is used to generally refer to structure that facilitates electronic communication between two components, and may operate using wired or wireless technology.

Imaging apparatus 12 may be, for example, an ink jet printer and/or copier, an electrophotographic printer and/or copier, or an all-in-one (AIO) unit that includes a printer, a scanner, and possibly a fax unit. Imaging apparatus 12 includes, for example, a controller 20 and a print engine 22 connected to a chassis 24. A printing cartridge 25 is coupled to print engine 22 to facilitate printing. Imaging apparatus 12 also includes an interface port 26 connected to chassis 24 for facilitating connection to and communication with operator module 16. As such, operator module 16 is detachably attachable to imaging apparatus 12 via interface port 26. Interface port 26 communicates with controller 20 via a communication link 28.

Interface port 26 can form a dedicated docking station and operate using a proprietary or standardized protocol in facilitating communication between imaging apparatus 12 and operation module 16. Alternatively, interface port 26 can provide communication between imaging apparatus 12 and operator module 16 via a typical communication protocol, such as a universal serial bus (USB).

Controller 20 includes a processor unit and a memory 32, and can be formed as one or more Application Specific Integrated Circuits (ASIC). Alternatively, memory 32 can be in the form of a separate electronic memory, a hard drive, a CD drive, or any memory device convenient for use with controller 20. Controller 20 communicates with print engine 22 via a communications link 34. Controller 20 serves to process print data and to operate print engine 22 during printing.

In the context of the examples for imaging apparatus 12 given above, print engine 22 can be, for example, an ink jet print engine, a color electrophotographic print engine or thermal transfer engine, configured for forming an image on a sheet of print media 36, such as a sheet of paper, e.g., photo paper, or a transparency sheet or fabric. As an ink jet print engine, for example, print engine 22 operates printing cartridge 25 to eject ink droplets onto the sheet of print media 36 in order to reproduce text and/or images. As an electrophotographic print engine, for example, print engine 22 causes printing cartridge 25 to deposit toner onto the sheet of print media 36 via a photoconductive substrate, which is then fused to the sheet of print media 36 by a fuser (not shown), in order to reproduce text and/or images.

Host 14, which can be optional as to imaging system 10, can be, for example, a personal computer, including memory 38, an input/output (I/O) device 40, an I/O port 42, and an I/O port 44. I/O device 40 can be, for example, a keyboard, mouse and/or a display monitor. Memory 38 can be, for example, random access memory (RAM), read only memory (ROM), and/or non-volatile RAM (NVRAM). I/O ports 42, 44 can be, for example, typical communications ports, such as a universal serial bus (USB) port, or other serial or parallel port, and can be configured for wired or wireless communication. Host 14 further includes a processor, such as a microprocessor, and can further include at least one mass data storage device, such as a hard drive, a CD-ROM and/or a DVD unit.

During a printing operation involving print data supplied by host 14, host 14 includes in its memory a software program including program instructions that function as an imaging driver 46, e.g., printer driver software, for imaging apparatus 12. Imaging driver 46 is in communication with controller 20 of imaging apparatus 12 via communications link 18. Imaging driver 46 facilitates communication between imaging apparatus 12 and host 14, and can provide formatted print data to imaging apparatus 12, and more particularly, to print engine 22, to print an image. Alternatively, however, all or a portion of imaging driver 46 can be located, for example, in controller 20 of imaging apparatus 12, as may be the case, for example, when imaging apparatus 12 is operating in a standalone mode.

Operator module 16 facilitates user interaction with imaging apparatus 12 when operator module 16 is attached to interface port 26, and can function as a standard operator panel for imaging apparatus 12. In addition, operator module 16 can serve as a personal portable data playback, acquisition and storage device, and can be used, for example, for the mass storage of digital images and/or audio files, when either attached to or detached from imaging apparatus 12.

Operator module 16 is configured for detachable attachment to interface port 26 of imaging apparatus 12. Operator module 16 includes a mechanical interface 48 for mechanically coupling operator module 16 to interface port 26 of imaging apparatus 12. Operator module 16 also includes an electrical interface 50 for electrically connecting operator module 16 to interface port 26. As mentioned above, interface port 26 can be, for example, a docking station for mechanically and electrically connecting to and receiving operator module 16.

Operator module 16 can further include a controller 52, a user interface 54, a memory device 56, a dedicated power source 58, a communications port 60, a memory card port 62, and an audio port 64. User interface 54 includes an input device 66 and a display device 68. Input device 66 can be, for example a keyboard, touch pad, and/or a joystick for facilitating user input to operator module 16. Display device 68 can be, for example, a liquid crystal display (LCD) or plasma display. Also, input device 66 can be integrated with display device 68 to form a touch screen display.

Power source 58 supplies electrical power to each of the electrical components, such as controller 52, user interface 54, and memory device 56, of operator module 16 and can be, for example, at least one battery, such as a rechargeable battery. Since operator module 16 has a dedicated power source 58, user interaction with user interface 54 and memory device 56 may be facilitated when operator module 16 is detached from interface port 26 of imaging apparatus 12. When operator module 16 is attached to imaging apparatus 12, the power source 58, such as a rechargeable battery, is charged by the power supplied by imaging apparatus 12.

Controller 52 includes a processor, such as a microprocessor having an associated memory, and may be formed as one or more ASICs. Controller 52 executes program instructions resident in memory, such as memory device 56 or other memory, to perform the functions of a typical printer operator panel, as well as to perform functions to facilitate the transfer of data with mechanical/electrical interfaces 48, 50, user interface 54, memory device 56, communications port 60, memory card port 62, and/or audio port 64. Controller 52 can also execute program instructions to perform predefined tasks, such as, for example, image editing, and formatting and/or transferring image data, such as transferring photographic images stored in memory device 56, to imaging apparatus 12 for printing.

Controller 52 is communicatively coupled to user interface 54 via a communications link 70. Controller 52 is communicatively coupled to memory device 56 via a communications link 72. Controller 52 is communicatively coupled to communications port 60 via a communications link 74. Controller 52 is communicatively coupled to memory card port 62 via communications link 76. Controller 52 is communicatively coupled to audio port 64 via a communications link 78. The connectivity between controller 52 and the various components of operator module 16 is exemplary, and is simplified for ease of understanding of the invention. Those skilled in the art will recognize that other interface hardware may be used in addition to that specifically shown in FIG. 1. Further, although communication links 70, 72, 74, 76, 78 are shown as individual links, it should be understood that they can be implemented as a single bus system within operator module 16.

Memory device 56 can be semiconductor memory, or disk memory, such as a hard disk, read/write (RW) CD or RW-DVD disk media, to provide mass storage of data, such as for example, digital images, e.g., digital photographs, and audio files, such as MP3 files, as well as personal data files, business data files, etc. In one embodiment, for example, memory device 56 can be sized to store five gigabytes of digital data, or more. Of course, typically, as the data capacity of memory device 56 increases, so does cost. Accordingly, initial memory capacity of memory device 56 can be made available in various sizes, such as for example, 5, 10 and 20 gigabytes, or more, depending on a user's needs or desires. Further, operation module 16 can be designed to accept memory expansion cards and/or disks to facilitate future memory expansion.

Communications port 60 is electrically and/or mechanically configured to facilitate communication with an external device, such as for example, host 14. For example, host 14 can transfer or receive data, such as digital images and/or audio files, via a communications link 80 connected to communications port 60. Data received through communications port 60 can be processed by controller 52 and stored in memory device 56.

Memory card port 62 is electrically and/or mechanically configured to facilitate communication with an external memory card 82, such as for example, the type of memory card commonly used in digital cameras. After insertion of memory card 82 into memory card port 62, a user can transfer all or a portion of the data, e.g., digital images, stored in memory card 82 to memory device 56 by entering appropriate instructions via user interface 54, wherein data received through memory card port 62 may be processed by controller 52 and stored in memory device 56.

Audio port 64 is electrically and/or mechanically configured as an audio input to facilitate communication with an audio source, such as a portable CD or DVD player, or configured as an audio output to a speaker or headphones. For example, by entering appropriate instructions via user interface 54, audio data received through audio port 64 may be processed by controller 52 and stored in memory device 56. Also, by entering appropriate instructions via user interface 54, audio data may be retrieved from memory device 56 and transferred through audio port 64 to headphones for audio playback.

The following is an example of the use of operator module 16, first when attached to the imaging apparatus 12, and second, when detached from imaging apparatus 12.

In this example, it may be desirable to operate imaging apparatus 12 without host 14, e.g., in a standalone mode for digital image processing. As such, a user may communicate with operator module 16 via user interface 54 to access and/or edit digital images. The digital images may be, for example, digital photographs or computer generated images. For example, a user may have some digital images, which are transferred into memory device 56 of operator module 16, or are indirectly accessed on memory card 82 by operator module 16. Accordingly, the present invention allows a user to perform actions on the digital images obtained by or stored in operator module 16. By using a standard imaging protocol, such as for example, Pictbridge, digital images may be transferred to imaging apparatus 12, operating in a standalone mode, to perform the image printing on the sheet of print media 36, such as photo paper.

Further, the user may desire to use operator module 16 detached from imaging apparatus 12 to take advantage of the portability of operator module 16 and its ability to function as a personal portable data playback, acquisition and storage device. For example, a user may desire to edit digital images stored in memory device 56 of operator module 16 while traveling. The user enters instructions to operator module 16 via user interface 54, and controller 52 executes appropriate image editing software/firmware to perform image editing of digital images stored in memory device 56, and/or digital images retrieved via communications port 60 or memory card port 62. Thereafter, the edited digital images can be stored in memory device 56 for further viewing on display device 68 of user interface 54.

At a later time, if desired, operator module 16 can be reattached to imaging apparatus 12, and some or all of the stored images can be transferred or copied from memory device 56, in whole or in part, to a memory associated with imaging apparatus 12, such as memory 32. The transfer can be made, for example, by accessing a transfer function on user interface 54 of operator module 16.

While this invention has been described with respect to an exemplary embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging system, comprising:
an imaging apparatus having a print engine and an interface port; and
an operator module configured for detachable electrical and mechanical attachment to said interface port, said operator module including a memory device for storing data, a user interface and a dedicated power source electrically coupled to said user interface and said memory,
said operator module being configured to facilitate user interaction with said imaging apparatus when said operator module is attached to said interface port,
said operator module being configured to facilitate playback of data when said operator module is detached from said interface port.

2. The imaging system of claim 1, wherein said operator module is configured to facilitate storage and retrieval of said data in said memory device when said operator module is detached from said imaging apparatus.

3. The imaging system of claim 1, wherein said data stored in said memory device is digital images.

4. The imaging system of claim 1, wherein said data stored in said memory device is audio files.

5. The imaging system of claim 1, wherein said memory device has a storage capacity of at least five gigabytes.

6. The imaging system of claim 1, wherein said memory device is at least one of a semiconductor memory, hard disk and a read/write disk media.

7. The imaging system of claim 1, said operator module comprising:
a mechanical interface for mechanically coupling said operator module to said interface port; and
an electrical interface for electrically connecting said operator module to said interface port.

8. The imaging system of claim 1, wherein said interface port is a docking station.

9. The imaging system of claim 1, wherein said operator module further comprises a memory card port.

10. The imaging system of claim 9, wherein said user interface facilitates a transfer of data from an external memory card inserted into said memory card port to said memory device contained in said operator module.

11. The imaging system of claim 1, wherein said operator module further comprises an audio port for facilitating communications with an audio device.

12. The imaging system of claim 1, wherein said operator module further comprises a communication port for facilitating communication with an external device.

13. The imaging system of claim 12, wherein said external device is a host computer.

14. The imaging system of claim 1, wherein said dedicated power source includes at least one battery.

15. The imaging system of claim 1, further comprising a host computer.

16. An operator module, comprising:
a controller;
a user interface communicatively coupled to said controller;
a memory device communicatively coupled to said controller;
a dedicated power source for supplying power to said controller, said user interface and said memory device; and
an electrical/mechanical interface to facilitate detachable attachment of said operator module to an imaging apparatus, said operator module facilitating user interaction with said imaging apparatus when said operator module is attached to said imaging apparatus, said operator module facilitating playback of data via said user interface and said memory when said operator module is detached from said imaging apparatus.

17. The operator module of claim 16, further comprising a memory card port, said user interface facilitating a transfer of data from an external memory card inserted into said memory card port to said memory device.

18. The operator module of claim 16, wherein said memory device has a storage capacity of at least five gigabytes.

19. The operator module of claim 16, wherein said memory device is at least one of a semiconductor memory, hard disk and a read/write disk media.

20. The operator module of claim 16, wherein said operator module further comprises a memory card port.

21. The operator module of claim 16, further comprising an audio port for facilitating communications with an audio device.

22. The operator module of claim 16, further comprising a communication port for facilitating communication with an external device.

23. The operator module of claim 22, wherein said external device is a host computer.

24. The operator module of claim 16, wherein said dedicated power source includes at least one battery.
